(19) United States
(12) Patent Application Publication
(10) Pub. No.: US 2006/0107511 A1
(43) Pub. Date: May 25, 2006

(54) Methods and apparatus for centering spring reactive forces

(76) Inventor: Richard Pare, Speedway, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/284,834

(22) Filed: Nov. 22, 2005

Related U.S. Application Data
(60) Provisional application No. 60/630,316, filed on Nov. 23, 2004.

(51) Int. Cl. B23Q 17/00; B21F 35/00

(52) U.S. Cl. 29/407.1; 29/896.91; 29/407.09; 29/406

(57) ABSTRACT

One preferred embodiment of the present invention provides a method for centering the reactive force of a coil spring to an applied load. The method provides a coil spring which defines a spring natural centerline. The spring has opposing ends and at least one end coil with an end coil tip. Opposing loads with parallel load axes and at least one fixed load surface are applied to the opposing ends of the spring. The spring natural centerline is maintained parallel to the applied load axes. The end coil is initially engaged to at least one of the applied loads at a point substantially opposite the end coil tip. In an alternate embodiment of the present invention, a coil spring and an applied load are combined. A plurality of helically wound coils define a spring with a natural centerline and at least one end coil. The end coil defines an end coil tip. A load with at least one fixed load surface is applied parallel to the natural centerline, wherein the applied load initially engages the end coil at a point substantially opposite the end coil tip.

This application claims priority to and incorporates by reference U.S. Provisional Application Ser. No. 60/630,316 filed Nov. 23, 2004.

### FIELD OF THE INVENTION

Certain preferred embodiments of the present invention relate generally to centering reactive forces in a spring.

### BACKGROUND OF THE INVENTION

Three basic types of coil compression springs are known in the industry. An open end spring consists of a wire coil which typically follows a single helix angle to the end of the wire. An unground, closed end spring has an end with a reduced angle so the wire end touches the last coil of the spring. In a ground, closed end spring, the face of the final coil is shaped and ground flat such that when the face touches the last coil of the spring, a flat spring surface is produced that is substantially square to the central axis of the main helix. Most standard automotive suspension springs are open end springs as they are relatively inexpensive to produce. In contrast, most high-performance springs used in racecars are ground, closed end springs.

Typically, as a load is applied to compress a coil spring, the reactive force is not distributed evenly across the face of the spring. Where this load concentration occurs on the spring varies with the type of spring used. For example, in an open end spring the reactive force is concentrated between the end of the spring and the point at which the load leaves contact with the spring. As the load is increased, this point moves away from the end tip of the spring. In closed end springs, the reactive force is concentrated primarily at or near the end tip. The consequences of this uneven loading are illustrated in lateral or offset loads such as in vehicle suspension systems. In general, a vehicle suspension system is provided with a helical compression spring designed to provide a coil axis that coincides with the direction of reaction force of the spring. In a strut-type suspension system, a shock absorber is employed as a strut for positioning the vehicle's wheels. If there is a displacement between the load axis and the strut axis, a bending moment is exerted on the strut. This lateral force may prevent the piston from sliding smoothly in the guide to act as a shock absorber.

One of the most highly used coil springs types is the “closed and ground” style spring, shown illustrated in FIGS. 1A and 1B between fixed parallel load surfaces 40 and 44. In spring 8 the last coil 11 is wound at a helical angle shallower than that of the main body of the spring 8 in order to allow the cut end 12 of the wire to touch the end of the previous coil. The last coil 11—the “end coil”—is then ground to produce a surface that is substantially flat and preferably square; (i.e. perpendicular) to the spring central axis C. Often the opposing end is ground in the same manner. It has always been presumed that producing such a precision surface would centralize the spring reactive loads, and minimize the potential for the production of undesirable lateral loads.

However, in springs of this type, as illustrated by vector arrows in FIG. 1A, the reactive force produced within the wire of the spring in the compressed (stressed) state is actually concentrated near the cut wire end, in the area of the overlap between the last active coil and the end coil 14, and does not spread over the full face of the end coil in an equal manner. As a result, the virtual spring load axis V_{L} (FIG. 1A) in these springs is resolved at an angle, or an offset, to the spring central axis C, with that angle or offset dependent on many factors in the design of the spring, the bearing surfaces against which it is loaded, and the load level. The offset load axis produces highly undesirable side loads (lateral loads) upon those load bearing surfaces, which decrease the spring efficiency, for example by increasing frictional losses in most devices upon which that spring is loaded.

### SUMMARY OF THE INVENTION

One preferred embodiment of the present invention, provides a method for centering the reactive force of a coil spring to an applied load. The method provides a coil spring which defines a spring natural centerline. The spring has opposing ends and at least one end coil with an end coil tip. Opposing loads with parallel load axes and at least one fixed load surface are applied to the opposing ends of the spring. The spring natural centerline is maintained parallel to the applied load axes. The end coil is initially engaged to at least one of the applied loads at a point substantially opposite the end coil tip.

In an alternate embodiment of the present invention, a coil spring and an applied load are combined. A plurality of helically wound coils define a spring with a natural centerline and at least one end coil. The end coil defines an end coil tip. A load is applied parallel to the natural centerline with at least one fixed load surface, wherein the applied load initially engages the end coil at a point substantially opposite the end coil tip.

Further objects, features and advantages of the present invention shall become apparent from the detailed drawings and descriptions provided herein. Each embodiment described herein is not intended to address every object described herein, and each embodiment does not include each feature described. Some or all of these features may be present in the corresponding independent or dependent claims, but should not be construed to be a limitation unless expressly recited in a particular claim.

### BRIEF DESCRIPTION OF THE DRAWINGS

FIGS. 1A and 1B illustrate a prior art closed end ground spring between fixed load surfaces.

FIG. 2A illustrates a prior art closed end ground spring between a fixed load surface and a non-fixed load surface.

FIG. 2B illustrates a prior art closed end ground spring between two non-fixed load surfaces.

FIGS. 3-5 illustrate a sequence of load distribution of a spring according to a preferred embodiment of the present invention.

FIGS. 6A-6C illustrate a sequence of load distribution of a spring according to a second preferred embodiment of the present invention.

FIGS. 7A-7C illustrate a sequence of load distribution of a spring according to a third less preferred embodiment of the present invention.

### DESCRIPTION OF PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, and alterations and modifications in the illustrated device and method and further applications of the principles of the invention as illustrated therein, are herein contemplated as would normally occur to one skilled in the art to which the invention relates.

Coil springs are used in a variety of applications. For example, in the vehicle industry, they are used in suspension systems with struts, or in a different application with valves and valve lifter assemblies. Such uses prefer to maximize efficient spring performance, for example, balancing spring weight and size for a desired load and reaction. In order to reduce or eliminate the lateral loads which result when using prior art springs, the end coil or engagement method can be pre-arranged and allowed to flex relative to the spring natural centerline to reach a perpendicular or “square” orientation as the spring accepts loads upon its full face. The allowance for flexing, or the ability to “tilt” to square relative to the spring central axis upon loading, allows the force developed within the stressed spring wire to distribute itself evenly around the face of the end coil. Once the loading is evenly distributed, the spring load, by definition, is centered on the spring central axis, and lateral load production is eliminated.

In some cases, the surface upon which the spring acts can be designed to allow this desired end coil flexing or tilting ability apart from the spring. Examples of spring perch devices which allow tilting apart from the spring through a mechanical movement can be seen in U.S. patent application Ser. No. 10/205,163, filed Jul. 25, 2002. At present, these tilting spring “perches” are in use in the automobile and motorcycle racing industry to decrease frictional losses in spring-over-damper assemblies (“coilovers”), with the result being increased tire grip, and faster lap times. There are, however, many applications within which separate spring perches cannot be physically fit due to space restrictions, or where operating conditions are too severe for long-term operation reliability.

Preferably, embodiments of the present invention automatically center the load on a coil spring from at least one, or alternately two, fixed load surfaces through modification of the physical construction of the spring, or modification of the engagement between the spring and the surfaces through which the external load is applied. Equal distribution of an applied load can be produced by “pre-tilting” or “reverse tilting” the end coils or the load surfaces in such a manner that the end coils flex as desired during the initial application of the designed load. In certain preferred embodiments of the present invention, it is possible to significantly reduce the development of undesirable lateral loads by pre-tilting or reverse tilting the end coil of the spring or the load surface in a manner that will produce concentric and equal loading about the face of that end coil at a specified load level, and near-concentric loading at load levels somewhat lesser and greater than that specified load. Alternately, the engagement with the load surface can be configured to create a tilted effect.

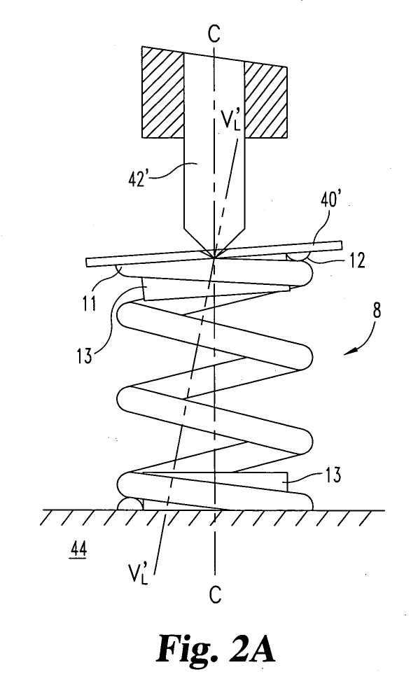

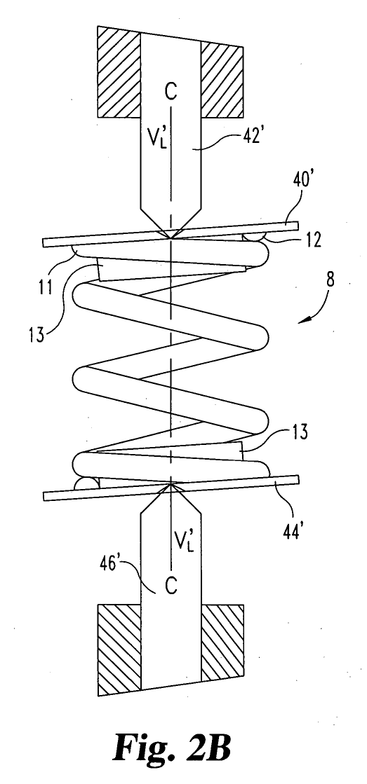

In contrast to two opposing fixed load surfaces, FIGS. 2A and 2B illustrate arrangements of a square ground spring between at least one fixed surface and a free-to-tilt surface, such as a spring perch, or between two free-to-tilt surfaces respectively. In an arrangement between a fixed surface and a tiltable spring perch, the tilting action of the spring perch distributes the load on the spring face at one end of the spring, reducing the offset of the virtual load axis, and causing the virtual load axis to be in greater, although not complete, alignment with the spring natural centerline. In an arrangement between two tiltable spring perches, the offset of the virtual load axis at each end is substantially eliminated by the tilting movement of the perches which distribute the opposing loads on the spring face, and causes the virtual load axis to be substantially aligned with the spring natural centerline. This distribution does not occur between a spring end and a fixed load surface. Certain preferred embodiments of the present invention are used with at least one, and alternately two, fixed load surfaces.

In greater detail, FIG. 2A illustrates one embodiment of the present invention, with a square ground spring 8 between a fixed lower surface 44 and a non-fixed upper load applying surface 40′. In the illustration, the spring upper load application surface 40′ is free to tilt with the end coil during application of the upper external load 42′ in response to the spring reactive forces. For the purpose of clarity, the external load 42′ is shown to be a point applied at the plane across a surface on the upper end coil 11 of the spring. A spring ID or “inner diameter” flange 13 is illustrated with each load surface as an example means to retain the spring perch in position.

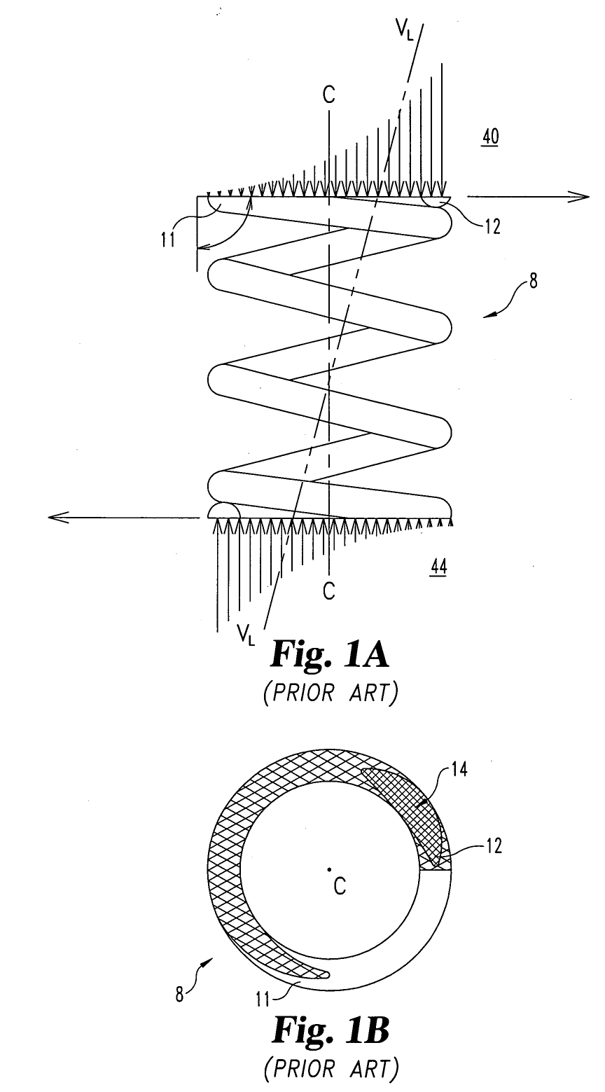

As the load is applied, the load application surface 40′ tilts in response to the spring reactive forces until those forces become equally distributed about the face of the end coil, at which time the applied load V_{L}′ and the spring reactive forces are in equilibrium at the spring upper surface, and the spring reactive force at the spring upper surface is centered at the point of external load application and is coincides with the spring natural centerline C at that upper surface. In contrast, the lower load surface 44 is fixed and does not tilt with the lower end coil. This results in the spring reactive virtual load axis V_{L}′ being offset from the spring centerline C when the spring is loaded. The offset of the virtual load axis V_{L}′ has been substantially reduced compared to FIG. 1, and is now in substantially greater agreement with the spring natural centerline C.

FIG. 2B illustrates a square ground spring 8 between two non-fixed load application surfaces such as spring perches 40′ and 44′. In the illustration, both perches are free to tilt with the end coils during compression. For the purpose of clarity, the external loads 42′ and 46′ are shown to be points applied to the spring perches at the planes describing the coil surfaces. As the external load is applied, the load application surfaces tilt in response to the spring reactive forces until those forces become equally distributed about the faces of the end coils, at which time the virtual load axis V_{L}′ is in agreement with the natural spring centerline C. This distribution does not occur if the load application surfaces are fixed.

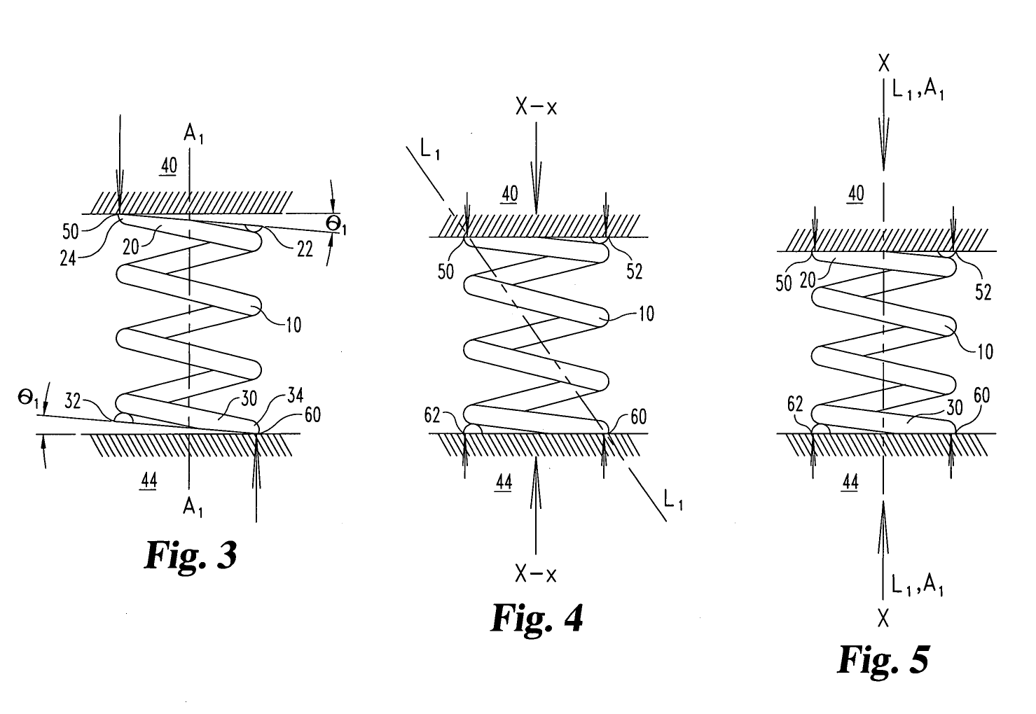

A spring according to one preferred embodiment of the present invention is illustrated in a side view in FIG. 3 in combination with parallel fixed load surfaces 40 and 44. Spring 10 is formed of a helical wire or metal coil wound with substantially equal turning angles except for the end coils. Upper end coil 20 is wound in a shallower or a horizontally “reverse” angle to the coil angles of the remainder of spring 10, so that upper wire tip 22 contacts the adjacent or prior coil. The reverse angle can be characterized as offset in a direction across an axis perpendicular to the spring natural centerline, the direction being opposite the turning angle direction of the other coils. Similarly, lower end coil 30 is wound with a reverse angle so that lower wire tip 32 contacts the adjacent or prior coil. For the sake of clarity, the illustration shows the upper and lower tip ends wound to end in symmetric positions 180 degrees apart. In actual practice, the ends may be clocked at positions other than symmetrical.

In spring 10, the upper end coil 20 is arranged so it is “reverse-tilted” at an angle θ₁ extending from upper wire tip 22 to the diametrically opposed point 24 of end coil 20. Preferably this angle is slightly offset from perpendicular to the spring central axis A₁. As illustrated in FIG. 3, when the spring is oriented vertically, the perceived tilt of spring 10 results in the highest point or point of initial contact 50 with upper load surface 40 being a point 24 substantially diametrically opposite the tip 22. For upper end coil 20, the reverse angle θ₁ places end coil tip 22 below a line which intersects a point 24 substantially opposite coil tip 22 and which is perpendicular to the spring centerline A₁.

In one preferred embodiment, upper coil 20 is ground so that opposed point 24 is higher, i.e., has less grinding, than does wire tip 22. The angle θ₁ that can be ground will be limited by the thickness of the wire and the end coil winding angle.

FIG. 3 schematically illustrates spring 10 between parallel, fixed orientation load surfaces 40 and 44. Although not shown for clarity, spring 10 is maintained “vertical” or with axis A₁ perpendicular to the load surfaces, and in inhibited from tilting as an entire structure. In certain embodiments, contact points 50 and 60 are retained from lateral movement. The retention can occur through friction, or for example with an ID guide 13 such as shown in FIG. 2B, an outer diameter guide, a fastener, a bracket, a seat, a flange or a similar physical restraint.

As further illustrated in FIG. 3, when the spring is oriented vertically, the perceived resulting lowest point or point of initial contact 60 with lower load surface 44 is opposing point 34. Preferably, the lower end coil 30 is ground at a parallel angle θ₁ to the upper end coil 20. For example, lower end coil 30 is ground at an angle extending from lower wire tip 32 to the diametrically substantially opposed point 34 of end coil 30. In the illustrated embodiment, lower coil 30 is ground so that opposed point 34 is lower than wire tip 32.

Preferably, the size, material, and tilt angles of spring 10 are selected and designed to distribute a specified applied load applied through load surfaces 40 and 44 to centralized distribution along natural spring center axis A, and to substantially eliminate lateral loading in a desired or preferred load range for the spring.

In one less preferred embodiment, a closed-end, unground spring with pre-tilted end coils is used. In an alternate, less preferred embodiment, an open end spring with pre-tilted end coils is used. In these embodiments, the upper and lower faces of the spring are pre-tilted by angling the upper and lower end coils from a base point in the coil adjacent the wire tip so that the end coil is tilted at an angle so that a point opposite the wire tip is higher or lower, respectively, than the corresponding upper or lower wire tip.

A load distribution progression as a designed load X is applied between two fixed parallel load surfaces 40 and 44 to spring 10 is illustrated in FIGS. 3-5. FIG. 3 shows spring 10 at the instant of initial contact with the load surfaces 40 and 44. The initial contact points 50 and 60 are approximately 180 degrees circumferentially away from the upper and lower wire ends 22 and 32 respectively. In this position, no load is yet applied to the spring and a gap exists between the coil end tips 22 and 32 and the load surfaces.

FIG. 4 shows the upper and lower end coils 20 and 30 in full contact with the load surfaces 40 and 44 at the instant that a pre-calculated portion (illustrated as “X-x”), for example with x=½, of the designed load X is applied. At this instant, a pre-calculated portion of the design load X has been absorbed by the flexing of the upper coil 20 and lower coil 30 from an angled upper and lower arrangement to a substantially flat or parallel engagement to load surfaces 40 and 44. At this point, there is zero or near zero load applied at tip contact points 52 and 62 between load surfaces 40 and 44 and the wire ends 22 and 32. The effective load axis L₁ is angled between initial contact points 50 and 60 under this applied load.

FIG. 5 shows the spring 10 partially compressed to accept the fully applied design load X. At this instant, in the example of x=½, substantially one-half of the applied load X is spread over one-half of the end coil face symmetrically around the circumference to either side of the respective initial contact points 50 and 60, and one-half of the applied load X is spread over the end coil face symmetrically around the circumference to either side of the tip contact points 52 and 62. Preferably at this instant and load, the applied load is evenly distributed over substantially the full face of the end coils, the load axis L₁ is centralized with the spring central axis A₁ and preferably there are no lateral loads produced.

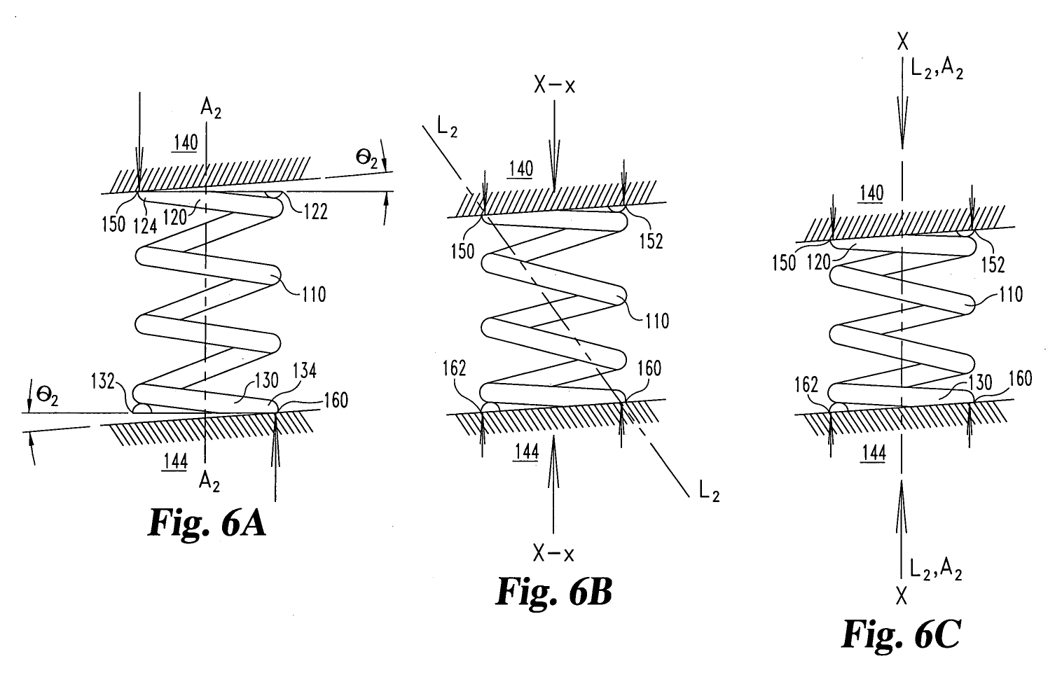

A second preferred embodiment with tilted or offset from perpendicular fixed load application surfaces is illustrated in FIGS. 6A-6C. FIG. 6A illustrates a side view of a standard closed-and-ground spring 110 with the ground end coil surfaces substantially perpendicular to the spring central axis A₂. In this example, the load axis is parallel with the spring axis A₂; however, the fixed load-applying surfaces 140 and 144 are tilted or offset at a reverse angle θ₂ measured from a line perpendicular to spring axis A₂. Angle θ₂ is calculated for a particular spring and the designed load level. In this example, points 124 and 134 are substantially opposite the coil end tips 122 and 132 and are arranged to contact the load applying surfaces first.

A load distribution progression as a designed load X is applied between two tilted load surfaces 140 and 144 to spring 110 is illustrated in FIGS. 6A-6C. For the sake of clarity, guides to keep the spring central axis A₂ in alignment with the load direction are omitted. FIG. 6A shows spring 110 at the instant of initial contact with the load surfaces 140 and 144. For illustration the initial contact points 150 and 160 are approximately 180 degrees circumferentially away from the upper and lower wire ends 122 and 132 respectively. In this position, no load is yet applied to the spring.

FIG. 6B shows the upper and lower end coils 120 and 130 in full contact with the load surfaces 140 and 144 at the instant pre-calculated portion X-x of the design load X has been absorbed by the flexing of the upper coil 120 and lower coil 130 from substantially flat upper and lower surface to a tilted or parallel engagement to load surfaces 140 and 144. At this point, there is zero or near zero load applied at tip contact points 152 and 162 between load surfaces 140 and 144 and the wire ends 122 and 132. The effective load axis L₂ is angled between initial contact points 150 and 160 under this pre-calculated load.

FIG. 6C shows the spring 110 partially compressed to accept the fully applied design load X. At this instant, with an example of x=½, substantially one-half of the applied load X is spread over one-half of the end coil face around the face circumference symmetrically to either side of the respective initial contact points 150 and 160, and one-half of the applied load X is spread over the end coil face for one-forth of the face circumference to either side of the tip contact points 152 and 162 at the points of closure. Preferably at this instant and load, the applied load X is evenly distributed over substantially the full face of the end coils, with the load axis L₂ centralized with the spring central axis A₂, and preferably there are no lateral loads produced.

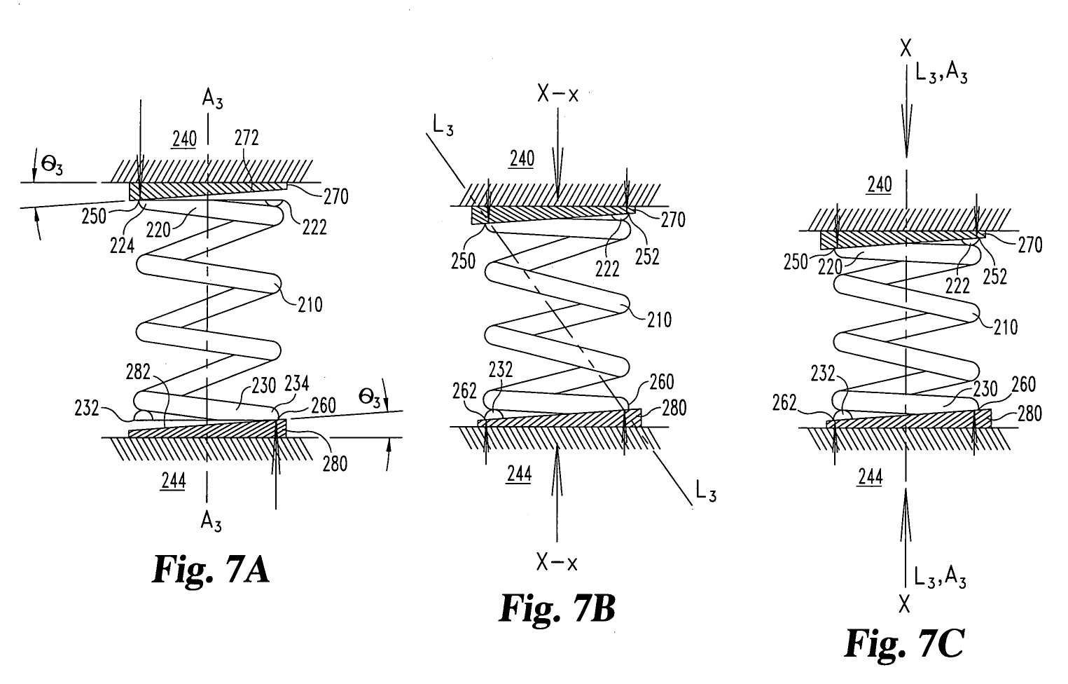

A third, less preferred embodiment illustrating a combination using tapered shims to create the effect of a tilted load engagement between fixed load application surfaces and a spring is illustrated in FIGS. 7A through 7C. FIG. 7A illustrates a side view of a standard closed-and-ground spring 210 with the ground end coil surfaces substantially square to the spring central axis A₃. For simplicity of illustration, the fixed load-applying surfaces 240 and 244 are substantially parallel or square to the spring and perpendicular to central axis A₃. Tapered shims 270 and 280 each have a load engaging surface and a spring engaging surface. The load engaging surface and the spring engaging surface are non-parallel, and are tapered at an angle θ₃. Angle θ₃ is calculated for the desired spring and the desired load level. Angle θ₃ is a reverse angle slightly offset from perpendicular to spring axis A₃ In this example, points 224 and 234 are substantially opposite coil end tips 222 and 232, and arranged to contact the applied loads, via the shims, first.

As illustrated, shims 270 and 280 are shown with perpendicular surfaces abutting load surfaces 240 and 244 and a gap between end coil tips 222 and 232 and the load surfaces. Alternately, the shims can be reversed so that the perpendicular surfaces abut end coils 220 and 230, yet still define a reverse angle and a gap between the end coil tips 222 and 232 and the load surfaces. In a preferred embodiment, two shims are used between two fixed, parallel load surfaces; alternately one shim can be used for a partial effect or alternately a combination may have one shim at one end of a spring and a reverse tilted end coil or reverse tilted load surface engaged at the opposing end.

Preferably, the shim engaging sides are configured to matingly engage with the load surface and the spring end coil surface respectively. In this context, the shim surface is configured when engaged to have a substantially continuous contact with the respective surface. For example, in a closed-end spring, the engagement may be substantially planar. In an open end spring, the shim may have a helically matched surface to mate with an end coil. Although not shown for clarity, the shims optionally include flanges, such as the ID guides 13 shown in FIG. 2B, engaging the inside or outside of the spring coil to maintain the position of the shims to the spring.

A load distribution progression as a designed load X is applied between two fixed and shimmed load surfaces 240 and 244 to spring 210 is illustrated in FIGS. 7A-7C. FIG. 7A shows spring 210 at the instant of initial contact with shims 270 and 280 between the spring and load surfaces 240 and 244. The initial contact points 250 and 260 are approximately 180 degrees circumferentially away from the upper and lower wire tip ends 222 and 232 respectively. In this position, no load is yet applied to the spring.

The load surfaces are illustrated as parallel to each other and perpendicular to the load axis for ease of reference in the present example. Alternately, the load surfaces may be tilted with respect to a line perpendicular to the axis. Alternately the spring and the load surfaces may be tilted with respect to each other and/or with respect to the perpendicular to the spring centerline. In these arrangements, the angle θ₃ of each shim may be configured to compensate.

FIG. 7B shows the upper and lower end coils 220 and 230 in full contact with the parallel shimmed load surfaces 240 and 244 at the instant pre-calculated portion X-x of the design load X (for example with x=½) has been absorbed by the flexing of the upper coil 220 and lower coil 230 from a substantially flat upper and lower surface orientation to a tilted or parallel engagement to engage the spring engagement surfaces 272 and 282 of the shims. At this point, there is zero or near zero load applied at tip contact points 252 and 262 between shim engagement surfaces 272 and 282 and the wire ends 222 and 232. The effective load axis is substantially angled between initial contact points 250 and 260 under this pre-calculated load.

FIG. 7C shows the spring 210 partially compressed to accept the fully applied design load X. At this instant, in the example of x=½, substantially one-half of the applied load X is spread over one-half of the end coil face for one-forth of the face circumference to either side of the respective initial contact points 250 and 260, and one-half of the applied load X is spread over the end coil face for one-forth of the face circumference to either side of the tip contact points 252 and 262 at the points of closure. Preferably at this instant and load, the applied load X is evenly distributed over substantially the full face of the end coils, the load axis L₃ is centralized at the spring central axis A₃, and preferably there are no lateral loads produced.

While the invention has been illustrated and described in detail in the drawings and foregoing description, the same is to be considered as illustrative and not restrictive in character, it being understood that only the preferred embodiment have been shown and described and that all changes and modifications that come within the spirit of the invention are desired to be protected. The articles “a”, “an”, “said” and “the” are not limited to a singular element, and include one or more such element.

What is claimed is:

1. A method for centering the reactive force of a coil spring to an applied load, comprising:
providing a coil spring defining a spring natural centerline, said spring having opposing ends and having at least one end coil with an end coil tip;
applying opposing loads with parallel load axes and with at least one fixed load surface to said opposing ends of said spring;
maintaining said spring natural centerline parallel to the applied load axes;
initially engaging said end coil to said at least one fixed load surface at a point substantially opposite said end coil tip.

2. The method of claim 1, wherein said at least one fixed load surface is engaged to said end coil at a reverse angle offset from perpendicular to said spring natural centerline.

3. The method of claim 2, comprising winding said end coil at a reverse angle from a point substantially opposite said end coil tip.

4. The method of claim 3, comprising winding said end coil as a closed end coil and grinding said end coil at a reverse angle extending from said point substantially opposite said end coil tip to said end coil tip.

5. The method of claim 1, wherein said at least one fixed load surface is perpendicular to said spring natural centerline.

6. The method of claim 1, wherein said at least one fixed load surface is arranged at an angle offset from perpendicular to said spring natural centerline.

7. The method of claim 1, comprising placing a tapered shim between said at least one fixed load surface and said end coil.

8. The method of claim 1, wherein said opposing loads are applied through parallel fixed load surfaces.

9. The method of claim 8, wherein said parallel load surfaces are perpendicular to said natural spring axis.

10. The method of claim 8, wherein said parallel load surfaces are offset from perpendicular to said natural spring axis.

11. A combination of a coil spring and an applied load, comprising:
a plurality of helically wound coils defining a spring with a natural centerline;
at least one end coil;
an end coil tip defined by said at least one end coil;
an applied load parallel to said natural centerline, wherein said applied load has at least one fixed load surface;
wherein said at least one fixed load surface is configured to initially engage said end coil at a point substantially opposite said end coil tip.

12. The combination of claim 11, wherein the engagement of said applied load to said end coil defines a reverse angle offset from perpendicular to said spring centerline.

13. The combination of claim 12, wherein said end coil is wound at said reverse angle.

14. The combination of claim 12, wherein said end coil is ground to said reverse angle.

15. The combination of claim 11, wherein said plurality of coils and said at least one coil have substantially equal coil diameters.

16. The combination of claim 11, in combination with a tapered shim between said end coil and said at least one fixed load surface, said shim having a spring engaging surface to engage said end coil and a load engaging surface to engage the applied load, wherein said spring engaging surface is angled with respect to said load engaging surface.

17. The combination of claim 16, wherein said spring engaging surface of said shim matingly engages said end coil.

18. The combination of claim 16, wherein said spring engaging surface is offset from perpendicular to said spring natural centerline.

19. The combination of claim 16, wherein said shim initially engages said end coil at a point substantially opposite the end coil tip.

20. The combination of claim 16, wherein one of said spring engaging surface and said at least one fixed load surface is perpendicular to said spring natural centerline and wherein the other of said spring engaging surface and said at least one fixed load surface is offset at a reverse angle from said end coil.
